(19) United States
(12) Patent Application Publication
(10) Pub. No.: US 2008/0231405 A1
(43) Pub. Date: Sep. 25, 2008

(54) Vertical transformer

(75) Inventors: Ching-Sung Kung, Taoyuan Hsien (TW); Handy He, Taoyuan Hsien (TW); Johnson Li, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/987,241

(22) Filed: Nov. 28, 2007

(30) Foreign Application Priority Data
Mar. 21, 2007 (TW) 96204543

(51) Int. Cl. H01F 27/30

(52) U.S. Cl. 336/198

(57) ABSTRACT

A vertical transformer includes a bobbin and a core pair. The bobbin includes a winding region and a through hole. The through hole is disposed inside the winding region. The core pair includes a first core and a second core. The second core is inserted in the through hole against the first core. The vertical transformer reduces volume and meets required safety standards of the insulation distance of electric devices.

### BACKGROUND OF THE INVENTION

This Non-provisional application claims priority under U.S.C. §119(a) on Patent Application No(s). 0962045438, filed in Taiwan, Republic of China on Mar. 21, 2007, the entire contents of which are hereby incorporated by reference.

### FIELD OF THE INVENTION

The invention relates to a vertical transformer, and more particularly to a vertical transformer capable of reducing the volume and meeting the safety standards.

### DESCRIPTION OF THE RELATED ART

With the rapid development of technology, the application of electronic products is extensive. The process of converting drive voltage of electrical circuits in a transformer determines the stability of the supply of power. However, it is difficult to unify transformer specifications for different types of electronic products. In addition, potential danger may exist for a transformer for different types of electronic products due to the electric conversion involved. Thus, the transformer must be met safety standards.

FIG. 1 is an exploded view of a conventional vertical transformer 1. The vertical transformer 1 normally utilizes a pair of E-like iron cores 12a and 12b. To meet required safety standards, the insulation distance between the E-like iron core 12a and the pins 13 and the insulation distance between E-like iron core 12b and the circuit board 15 should be considered. Conventionally, the insulation distance can be obtained by increasing the height of the winding seat 11, but the volume of the vertical transformer 1 is relatively increased. The large-sized vertical transformer 1 is not suitable for the design of miniature products and costs and materials for producing the vertical transformer 1 are relatively increased. When reducing the diameter and circles of the winding pair 14 to reduce the volume of vertical transformer 1, insufficient supply of power for the vertical transformer 1 may occur and temperature of the vertical transformer 1 may increase, thus increasing danger for the vertical transformer 1.

### BRIEF SUMMARY OF THE INVENTION

The present invention provides a vertical transformer to minimize volume and meet required safety standards of insulation distance of electric devices. An embodiment of the vertical transformer includes a bobbin and a core pair. The bobbin includes a winding region and a through hole disposed in the winding region. The core pair includes a first core and a second core. The second core penetrating through the through hole is disposed in the through hole to press against the first core.

The vertical transformer further includes a winding pair circumferentially disposed on the winding region. The winding pair includes a primary winding and a secondary winding. The bobbin further includes a compartment used to receive the first core. The through hole and the compartment are connected. The bobbin further has two openings correspondingly formed with respect to the compartment, wherein the first core passing through the two openings is dispose in the compartment. The first core is formed in a plate-like shape, and the second core is formed in an E-like shape. The second core has an E-like central protrusion passing through the through hole to press against the first core. The first core and the second core are formed by a ferrite material, and the bobbin is made by an insulating polymer. The bobbin includes a plurality of pins for electrically connecting to a circuit board.

A detailed description is given in the following embodiment with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional vertical transformer.

FIG. 2 is an exploded view of a vertical transformer according to the preferred embodiment of the present invention.

FIG. 3A is a perspective view of a bobbin of FIG. 2.

FIG. 3B is a sectional view of the bobbin along line AA′ in FIG. 3A.

FIG. 4 is a schematic view of the vertical transformer of FIG. 2.

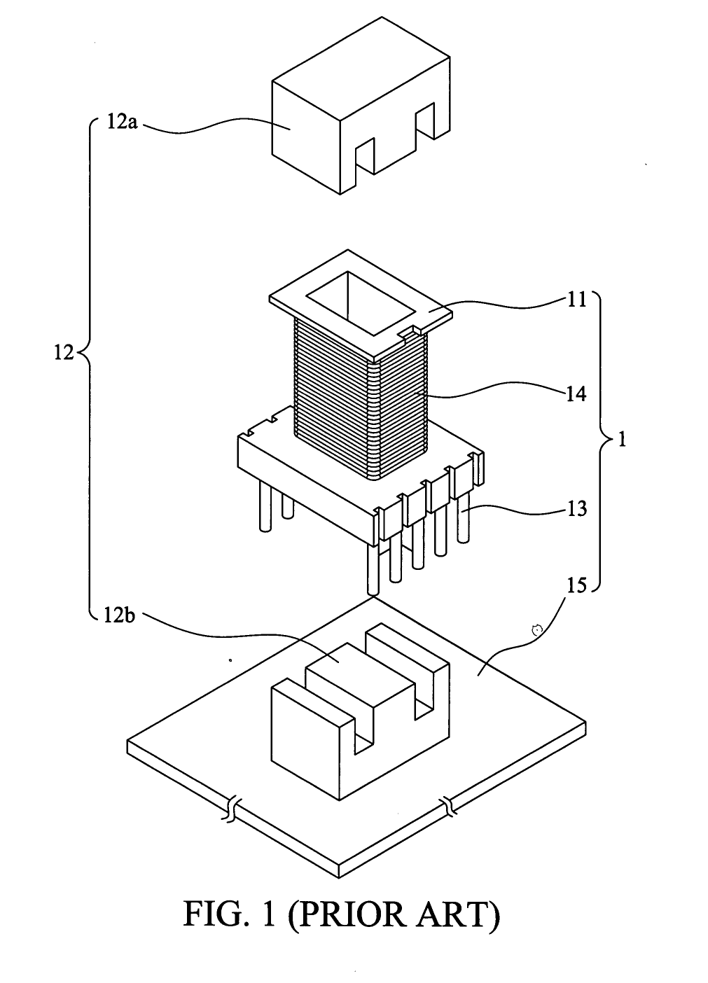

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

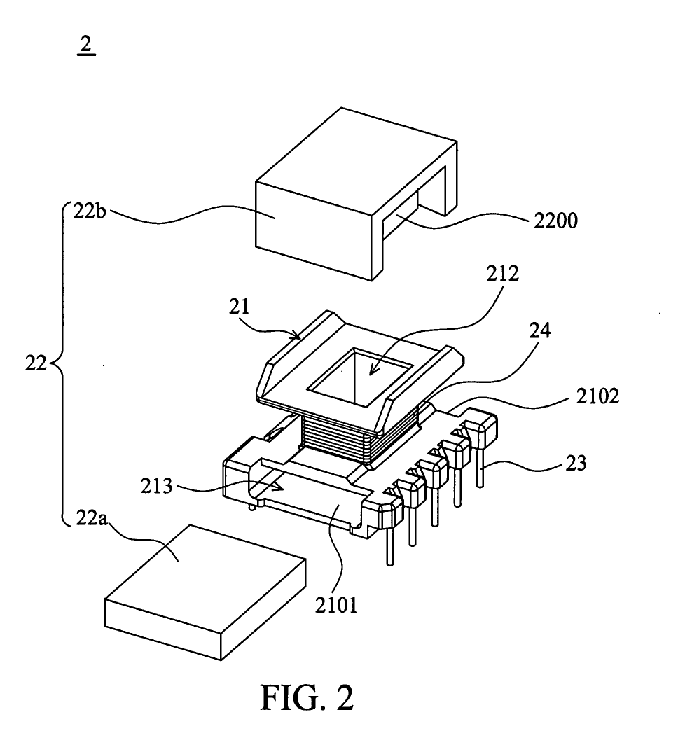

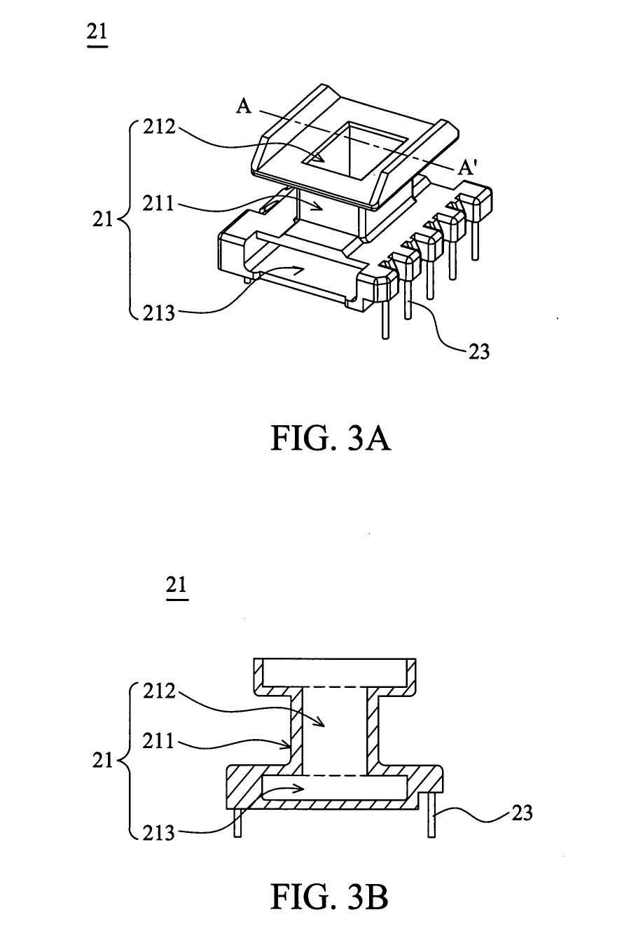

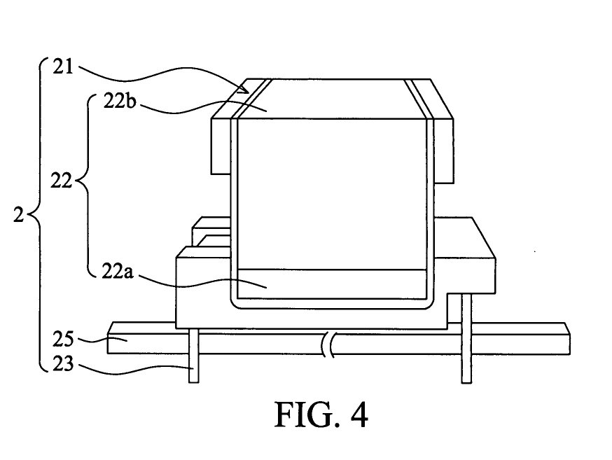

Referring to FIGS. 2, 3A, 3B and 4 simultaneously, FIG. 2 is an exploded view of a vertical transformer 2 according to the preferred embodiment of the present invention, FIG. 3A is a perspective view of a bobbin 21 of FIG. 2, FIG. 3B is a sectional view of the bobbin 21 along line AA′ in FIG. 3A, and FIG. 4 is a schematic view of the vertical transformer 2 of FIG. 2. The vertical transformer 2 includes the bobbin 21, a core pair 22 including a first core 22a and a second core 22b, and a winding pair 24 including a primary winding and a secondary winding. The bobbin 21 includes a winding region 211, a through hole 212 disposed in the winding region 211, a compartment 213 -connected to the through hole 212, two corresponding openings 2101 and 2102 connected to the compartment 213, and a plurality of pins 23. The first core 22a passing through the openings 2101 and 2102 is positioned in the compartment 213. In this embodiment, the bobbin 21 is made of insulating polymer. The winding region 211 is an area provided for the installment of the winding pair 24. Specifically, the winding pair 24 is circumferentially disposed on the winding region 211 of the bobbin 21. In FIG. 3B, the through hole 212 is connected to the compartment 213. Specifically, the through hole 212 and the compartment 213 share the same space. The first and second cores 22a and 22b of the core pair 22 are made of ferrite material. For the application of the vertical transformer 2, the first and second cores 22a and 22b are formed in plate-like shape and E-like shape, respectively. An E-like central protrusion 2200 of the second core 22b passes through the through hole 212 to press against the first core 22a. In FIG. 4, the pins 23 of the bobbin 21 are electrically connected to a circuit board 25 when the above assembling process is finished.

Due to the bobbin 21 made of insulating polymer, the first core 22a passing through the openings 2101 and 2102 is disposed in the compartment 213, providing isolating protection from the first core 22a to the circuit board 25 and the pins 23 and eliminating a need to increase volume of the first core 22a to obtain insulating effect and meet required safety standards. Thus, volume of the vertical transformer 2 is reduced, which benefits to be applied to miniature electronic products. Further, the need to reduce the diameter and circles of the winding pair 24 to decrease the volume of the vertical transformer 2 is also eliminated, and thus the manufacturing process is simplified and efficiency of the vertical transformer 2 is increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vertical transformer, comprising
a bobbin, comprising a winding region and a through hole disposed in the winding region; and
a core pair, comprising a first core and a second core, wherein the second core penetrates the through hole and is disposed in the through hole to press against the first core.

2. The vertical transformer as claimed in claim 1, further comprising a winding pair circumferentially disposed on the winding region.

3. The vertical transformer as claimed in claim 2, wherein the winding pair comprises a primary winding and a secondary winding.

4. The vertical transformer as claimed in claim 1, wherein the bobbin further comprises a compartment used to receive the first core.

5. The vertical transformer as claimed in claim 4, wherein the first core is formed in plate-like shape.

6. The vertical transformer as claimed in claim 4, wherein the through hole and the compartment are connected.

7. The vertical transformer as claimed in claim 4, wherein the bobbin further comprises two openings correspondingly formed with respect to the compartment, for allowing the first core to pass there through and to be disposed in the compartment.

8. The vertical transformer as claimed in claim 1, wherein the second core comprises an E-like central protrusion passing through the through hole to press against the first core.

9. The vertical transformer as claimed in claim 8, wherein the second core is formed in E-like shape.

10. The vertical transformer as claimed in claim 9, wherein the -first core is formed in plate-like shape.

11. The vertical transformer as claimed in claim 1, wherein the first core and the second core comprise a ferrite material.

12. The vertical transformer as claimed in claim 1, wherein the bobbin comprises an insulating polymer.

13. The vertical transformer as claimed in claim 1, wherein the bobbin comprises a plurality of pins.

14. The vertical transformer as claimed in claim 13, wherein the pins are for electrically connecting to a circuit board.
